(19) United States
(12) Patent Application Publication
(10) Pub. No.: US 2014/0164996 A1
(43) Pub. Date: Jun. 12, 2014

(54) APPARATUS, METHOD, AND STORAGE MEDIUM

(71) Applicant: CANON KABUSHIKI KAISHA, Tokyo (JP)

(72) Inventor: Takeshi Takahashi, Tokyo (JP)

(73) Assignee: CANON KABUSHIKI KAISHA, Tokyo (JP)

(21) Appl. No.: 14/096,739

(22) Filed: Dec. 4, 2013

(30) Foreign Application Priority Data
Dec. 11, 2012 (JP) 2012-270524

(51) Int. Cl. G06F 3/0482

(52) U.S. Cl. CPC G06F 3/0482
USPC 715/810

(57) ABSTRACT

An apparatus according to the present invention includes a display unit configured to display as each item in a list each of a plurality of character strings obtained by performing morphological analysis on text data; and a control unit, wherein in a case where a first operation is performed on a plurality of items specified by a user in the list, the control unit is configured to control the display unit to display as an item in the list a combined character string obtained by combining character strings corresponding to the plurality of specified items, and in a case where a second operation is performed on an item specified by the user in the list, the control unit is configured to control the display unit to display as new items in the list a plurality of character strings obtained by segmenting a character string corresponding to the specified item.

### BACKGROUND OF THE INVENTION

1. Field of the Invention

The present invention relates to a display apparatus, and more particularly to a display apparatus for displaying a plurality of character strings in a combined manner or in a separate manner based on instructions by a user.

2. Description of the Related Art

Systems for searching for the meanings or translations of words in a sentence generally use morphological analysis to divide the sentence to be searched into words and then to search for the meaning of each separate word.

However, the morphological analysis may divide a sentence by inappropriate word boundaries, causing the problem that a user is unable to obtain intended words.

For example, there is a case where a word, which should be regarded as a single word, obtained by dividing a sentence to be searched is segmented into more words than necessary. In contrast, there is another case where the sentence to be searched is not segmented appropriately, so that the sentence consisting of a plurality of words may be regarded as a single word.

There is known a technique, such as an electronic dictionary, in which in a case where a morphologically-analyzed character string has a plurality of possible segments delimited by boundaries, all of the character strings separated by the plurality of possible boundaries are acquired and stored as entries (see, for example, Japanese Patent No. 3377942).

According to the conventional technique, in the systems for displaying lists of words included in a document and their meanings, considerable variation in morphological analysis results leads to a significant level of noise in display, which may greatly reduce the convenience of users.

### SUMMARY OF THE INVENTION

The present invention has been made to solve the above problems, and provides an apparatus including: a display unit configured to display as each item in a list each of a plurality of character strings obtained by performing morphological analysis on text data; and a control unit, wherein in a case where a first operation is performed on a plurality of items specified by a user in the list, the control unit is configured to control the display unit to display as an item in the list a combined character string obtained by combining character strings corresponding to the plurality of specified items, and in a case where a second operation is performed on an item specified by the user in the list, the control unit is configured to control the display unit to display as new items in the list a plurality of character strings obtained by segmenting a character string corresponding to the specified item.

According to the present proposal, even in a case where candidates for boundary positions presented as morphological analysis results are inappropriate, it is possible to easily correct the boundary positions through operations by a user.

Further features of the present invention will become apparent from the following description of exemplary embodiments (with reference to the attached drawings).

### BRIEF DESCRIPTION OF THE DRAWINGS

FIG. 1 shows a system according to an embodiment of the present invention;

FIGS. 2A and 2B illustrate an exemplary touch-panel operation;

FIG. 3 shows an exemplary hardware configuration of a portable device according to an embodiment of the present invention;

FIG. 4 shows an exemplary hardware configuration of a server according to an embodiment of the present invention;

FIG. 5 shows a functional configuration in an embodiment of the present invention;

FIG. 6 is a flowchart of a process of event processing according to a first embodiment and a second embodiment of the present invention;

FIG. 7 is a flowchart of a process of segmentation processing according to the first embodiment of the present invention;

FIG. 8 is a flowchart of a process of combining processing according to the first embodiment of the present invention;

FIG. 9 is a flowchart of a process of combining processing according to the second embodiment of the present invention;

FIG. 10 is a flowchart of a process of event processing according to a third embodiment of the present invention;

FIG. 11 is a flowchart of a process of direct segmentation processing according to the third embodiment of the present invention; and

FIGS. 12A and 12B show an exemplary display screen of a portable device according to an embodiment of the present invention.

### DESCRIPTION OF THE EMBODIMENTS

Hereinafter, embodiments of the present invention will be described with reference to the drawings.

### First Embodiment

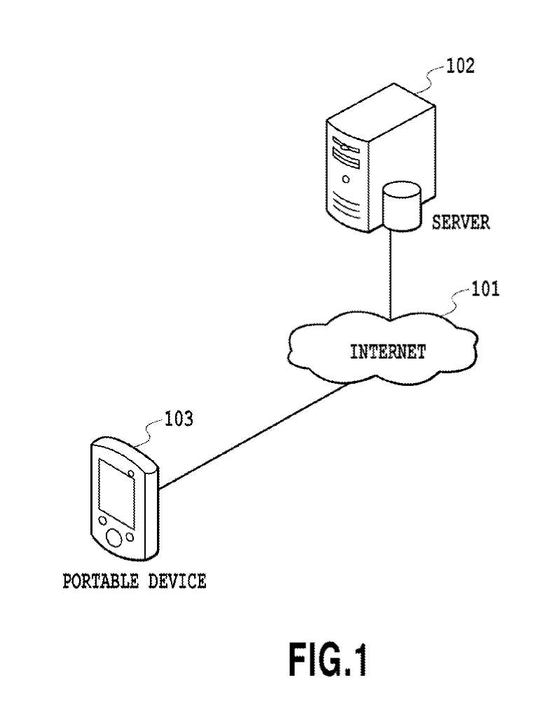

With reference to FIG. 1, an exemplary system for carrying out the present invention will be described in detail.

As shown in FIG. 1, the system includes an Internet 101, a server 102, and a portable device 103. The server 102 and the portable device 103 are connected with each other via the Internet 101.

The Internet 101 is a communication line for communicating information between the above-mentioned devices beyond a firewall. Data transmission from the portable device 103 to the server 102 is possible beyond a firewall. Incidentally, the Internet 101 is a communication network using, for example, TCP/IP protocols. However, not limited to the Internet, any form of connection, both wired and wireless connections, may be employed. Furthermore, although the system of FIG. 1 includes only one server 102, it may include a plurality of servers.

The system according to the present embodiment can convert speech data, such as conversations captured (or recorded) with a microphone provided for the portable device 103, into text data and analyze the text data by using the server 102. Then, the portable device 103 displays in turn the meanings or explanations of elements, such as nouns, included in the analyzed text data based on the processing results received from the server 102.

As described above, the system has the functions of analyzing speech and displaying a list of words (noun elements) obtained based on the analysis results on the portable device 103, without a character input (a word input) by a user. In addition, the portable device 103 can acquire the meanings of words obtained based on the analysis results and display the meaning of the word selected by a user.

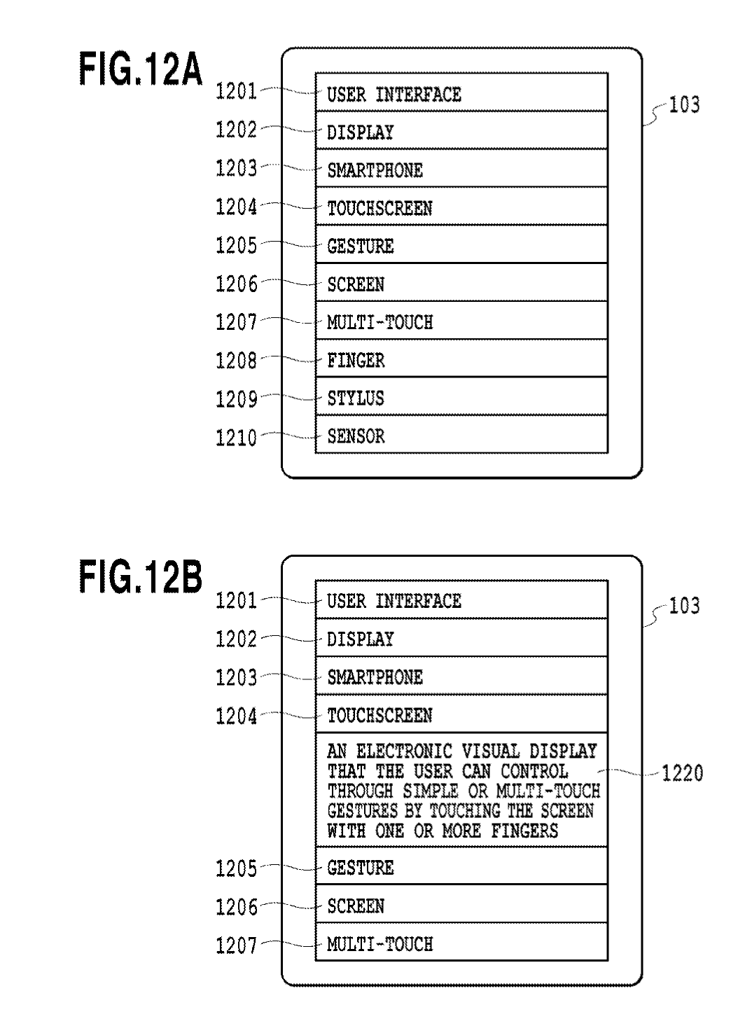

FIGS. 12A and 12B show exemplary display screens of the portable device 103 having a touch panel display. In word cells 1201 to 1210 of FIG. 12A, noun elements included in text data which is generated by converting input speech into text are displayed as items.

When the user taps one of the word cells 1201 to 1210 on the touch panel display with a finger, a meaning cell which includes the meaning and explanation of the noun displayed in the tapped word cell appears immediately below and adjacent to the tapped word cell.

For example, when the word cell 1204 (“touchscreen”) of FIG. 12A is tapped, a meaning cell 1220 appears which includes text related to the meaning of “touchscreen” associated with the word cell 1204 as shown in FIG. 12B.

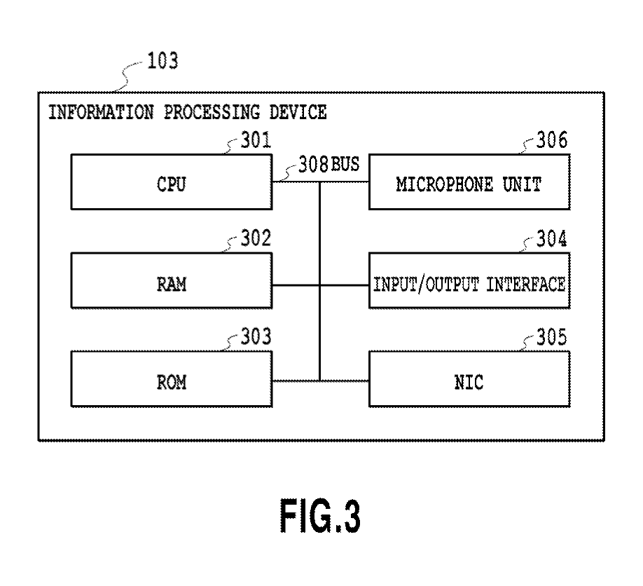

FIG. 3 shows an exemplary hardware configuration of the portable device 103.

The portable device 103 includes a CPU 301, a RAM 302, a ROM 303, an Input/Output interface 304, a network interface card (NIC) 305, a microphone unit 306, and a bus 308.

The CPU 301 loads programs from the ROM 303 and executes an operating system (OS) and general applications. Further, the CPU 301 generally controls the devices connected to the bus 308.

The ROM 303 stores an operating system program, which is a control program for the CPU 301, and various kinds of data.

The RAM 302 functions as a main memory, work area or the like for the CPU 301.

The Input/Output interface 304 controls indications on a display, touch input on the display, and others.

The NIC 305 is connected with an external network to control communication with other devices. Incidentally, the NIC may take any form as long as it is capable of controlling communication with external devices.

The microphone unit 306 includes a device such as a microphone and captures surrounding sound and voice in the form of digital signals.

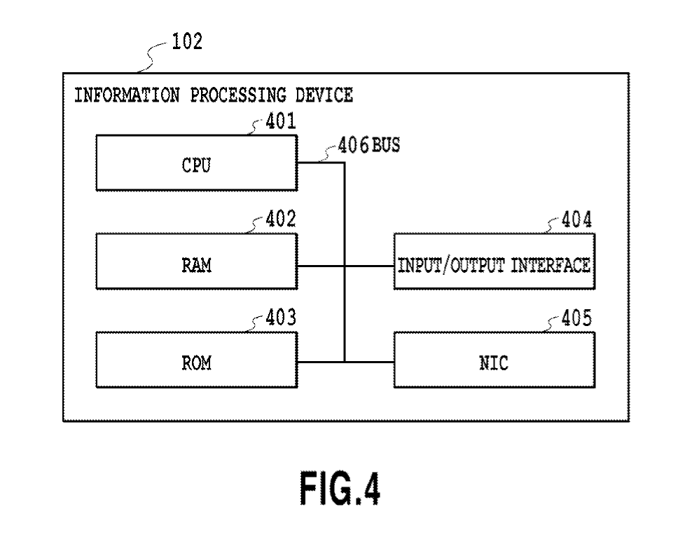

FIG. 4 shows an exemplary hardware configuration of the server 102.

The server 102 includes a CPU 401, a RAM 402, a ROM 403, an Input/Output interface 404, a NIC 405, and a bus 406. The Input/Output interface 404 controls indications on a display, key input, and others. Since other devices play the same role as in the portable device 103, the detailed description will be omitted.

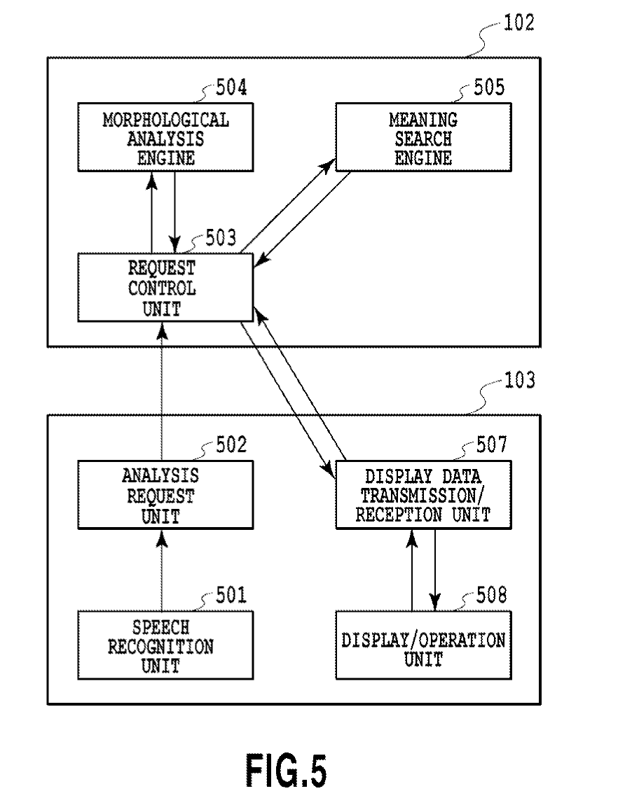

FIG. 5 shows a functional configuration of a system according to the present embodiment.

The server 102 and the portable device 103 load programs stored in their respective ROM 403 and ROM 303 into their respective RAM 402 and RAM 302 and execute them to achieve the functions shown in FIG. 5.

As shown in FIG. 5, the portable device 103 includes a speech recognition unit 501, an analysis request unit 502, a display data transmission/reception unit 507, and a display/operation unit 508.

The speech recognition unit 501 recognizes speech signals obtained by the microphone unit 306 and converts them into text data. Conversion from speech to text may be performed by use of a known technique.

The analysis request unit 502 transmits the text data obtained by the speech recognition unit 501 to a request control unit 503 of the server 102 and requests analysis of the text data.

The display data transmission/reception unit 507 receives the resulting data from the request control unit 503 and causes the display/operation unit 508 to display it. Further, the display data transmission/reception unit 507 requests the request control unit 503 to transmit the meaning of the word specified by the user based on an operation signal from the display/operation unit 508.

The display/operation unit 508 displays an output content transmitted from the display data transmission/reception unit 507 via the Input/Output interface 304. Further, the display/operation unit 508 transmits an operation content entered by the user to the display data transmission/reception unit 507 through the Input/Output interface 304 as an operation signal.

Meanwhile, the server 102 includes the request control unit 503, a morphological analysis engine 504, and a meaning search engine 505.

The request control unit 503 receives a request transmitted from the analysis request unit 502 or the display data transmission/reception unit 507 and activates the morphological analysis engine 504 and the meaning search engine 505 according to the content. Further, the request control unit 503 transmits the analysis result of the morphological analysis engine 504 and the processing result of the meaning search engine 505 to the display data transmission/reception unit 507.

The morphological analysis engine 504 performs morphological analysis on the text data whose analysis has been requested, retrieves elements such as nouns included in the text data, and creates character strings. Incidentally, a known technique may be used for a specific processing algorithm of the morphological analysis.

The meaning search engine 505 searches its dictionary data for the meaning of the requested word. Alternatively, the meaning search engine 505 may refer to other databases via the Internet 101. Then, the meaning search engine 505 transmits the obtained search results to the request control unit 503.

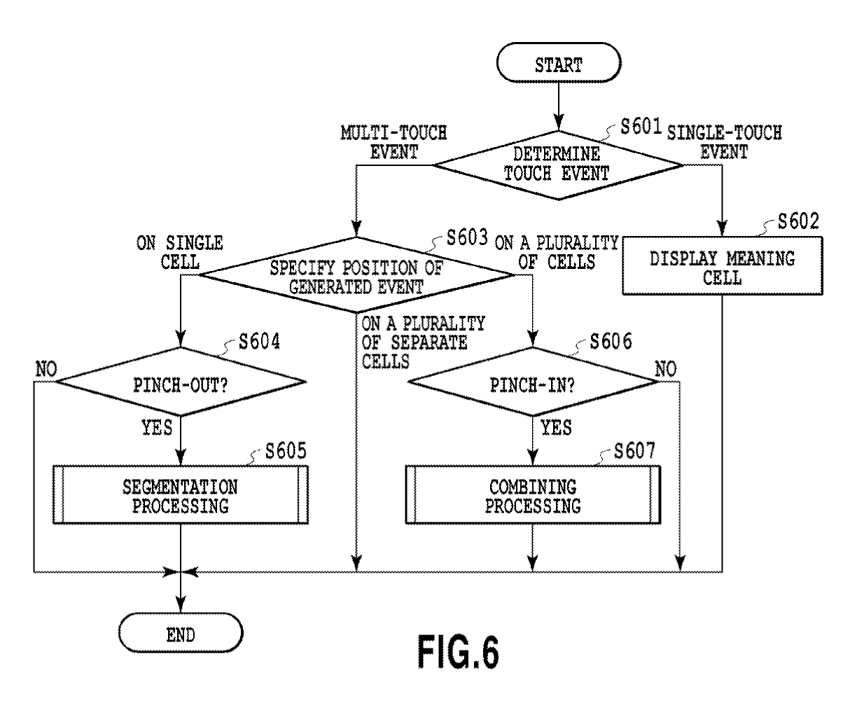

FIG. 6 is a flowchart of processing a generated event by operations and instructions by a user performed on the screen of the portable device 103. Incidentally, the event processing is performed on an event generated in the following circumstances: first, a speech input is provided by the user; then, the morphological analysis engine 504 analyzes text data corresponding to the speech data; and then, obtained elements are displayed as shown in FIGS. 12A and 12B.

First in step S601, the display/operation unit 508 determines the type of touch event. The touch event is either a single-touch event generated by a user touching the screen of the portable device 103 with a finger or a multi-touch event generated by a user touching the screen of the portable device 103 with two fingers.

In a case where the determination result is a single-touch event, the process proceeds to S602. In S602, the display/operation unit 508 displays a meaning cell corresponding to the touched word cell around the touched word cell, for example, immediately below and next to the touched word cell as shown in FIG. 12B.

On the other hand, in a case where the determination result is a multi-touch event, the process proceeds to S603. In S603, the display/operation unit 508 determines whether a position of the generated event, that is, a location of the touch by a user, is only on a single word cell or across two or more neighboring word cells. In a case where the event is generated only on a single word cell, the process proceeds to S604.

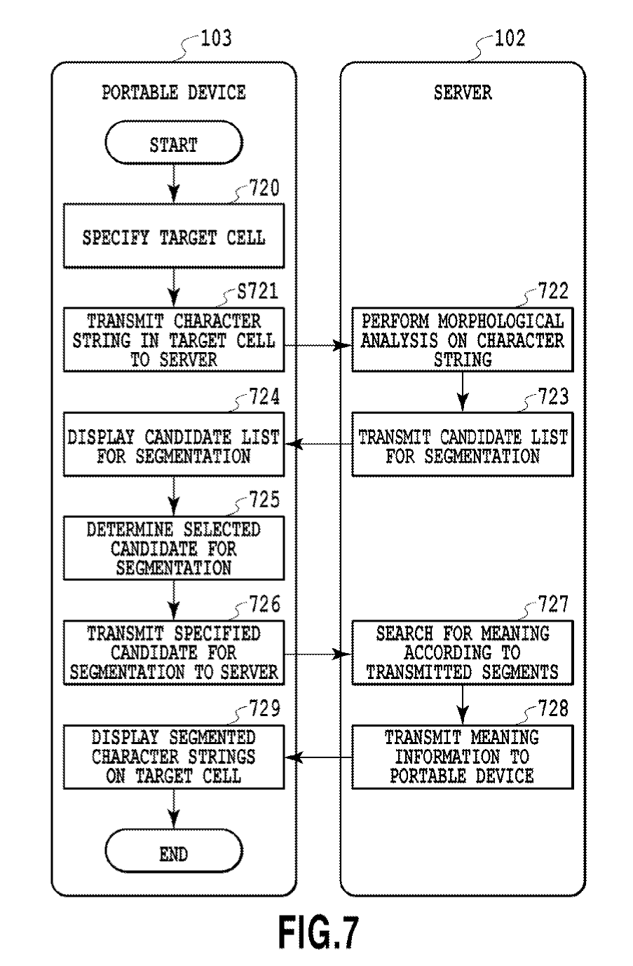

In S604, the display/operation unit 508 further determines whether the user action is a pinch-out. In a case where the user action is a pinch-out (YES in S604), segmentation processing is performed in S605. The segmentation processing is performed in accordance with the process shown in FIG. 7.

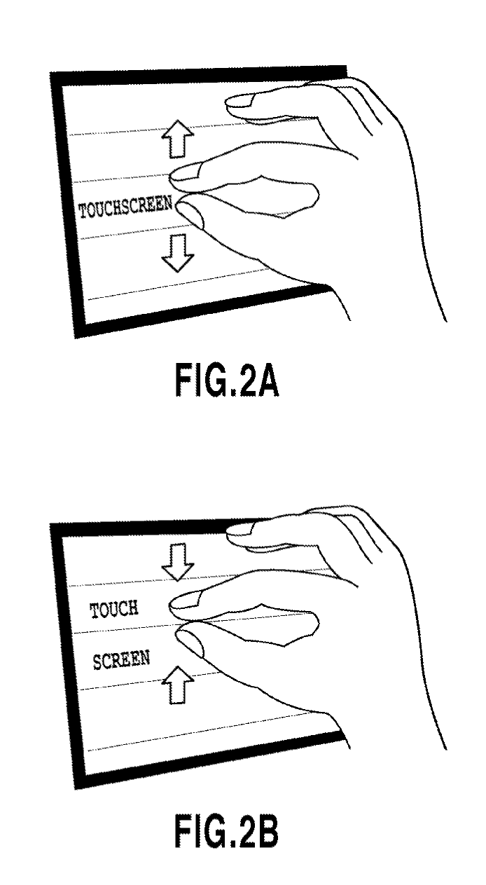

Incidentally, an exemplary pinch-out action performed by a user on a single word cell in the present embodiment is shown in FIG. 2A. More specifically, while touching the word cell with two fingers, the user gradually and directly moves the two fingers touching the screen away from each other in the opposite directions.

In a case where the event is generated across a plurality of cells, the process proceeds to S606.

In S606, the display/operation unit 508 determines whether an action corresponding to the event is a pinch-in.

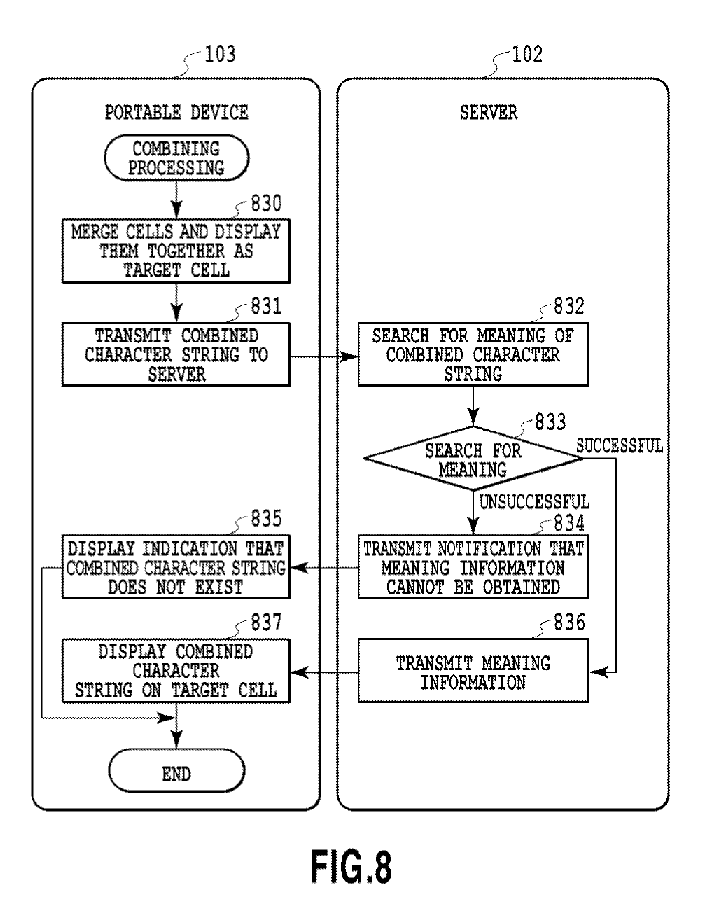

In a case where the action corresponding to the event is a pinch-in, combining processing is performed in S607. The combining processing is performed in accordance with the process shown in FIG. 8. An exemplary pinch-in action in the present embodiment is shown in FIG. 2B. More specifically, while touching different word cells with two respective fingers, the user gradually and directly moves the two fingers toward each other to bring them closer to a certain point on the screen.

Incidentally, even in a case where the event is determined to be generated across a plurality of cells in S603, if the cells are located a predetermined distance apart or more, it is very likely that the determination results from an incorrect operation. In such a case, no processing is performed and the process is completed.

<Segmentation Processing>

Next, a process of the segmentation processing in S605 will be described with reference to FIG. 7. In the segmentation processing, a first character string in the word cell selected by the user is segmented for display.

First in S720, the display/operation unit 508 specifies the word cell touched by the user as a target cell.

Then in S721, the display data transmission/reception unit 507 transmits text data associated with the word or character string in the target cell to the server 102.

Then in S722, the request control unit 503 of the server 102 causes the morphological analysis engine 504 to perform morphological analysis on the received text data. For instance, in a case where the received text data is “touchscreen,” the morphological analysis engine 504 finds a plurality of possible boundaries, such as “t/ouchscreen,” “to/uchscreen,” “tou/chscreen,” “touc/hscreen,” “touch/screen,” “touchs/creen,” “touchsc/reen,” “touchscr/een,” “touchscre/en,” “touchscree/n,” and these ten options are determined to be the candidates for segmentation. The phrase “candidates for segmentation” as used herein is equivalent to the phrase “candidates for boundary positions.”

Then in S723, the request control unit 503 transmits a candidate list for segmentation, that is, a list of one or more candidates for segmentation obtained by the analysis to the portable device 103.

Then in S724, the display/operation unit 508 displays the received candidate list for segmentation.

Then in S725, the display/operation unit 508 determines which candidate for segmentation is selected from the candidate list for segmentation based on the operation and instruction by the user.

In S726, the display data transmission/reception unit 507 transmits information indicating the selected candidate for segmentation to the request control unit 503 of the server 102.

In S727, the request control unit 503 activates the meaning search engine 505 to search for the meanings of words segmented according to the segments in the information indicating the transmitted candidate for segmentation.

In S728, the request control unit 503 transmits meaning information obtained by the search to the portable device 103.

In S729, the display/operation unit 508 displays character strings in a manner that the boundary/boundaries specified by the user can be recognized for the target cell.

Incidentally, since the user has obtained the meanings of the words in the segments associated with the target cell in the segmentation processing in S605, it is possible to immediately display the meaning of the word in the specified segment in response to a user's action (a single-touch event for the word after segmentation).

<Combining Processing>

Next, a process of the combining processing in S607 will be described with reference to FIG. 8.

First in S830, the display/operation unit 508 combines the plurality of word cells that the user first touches on the screen into one and displays it as a target cell. In a case where a plurality of cells exist between the two separate word cells touched by the fingers, all of the cells, including the pointed cells and the cells therebetween, may be merged together.

In S831, the display data transmission/reception unit 507 transmits a combined character string associated with the target cell obtained by combining a plurality of character strings to the server 102.

In S832, the request control unit 503 activates the meaning search engine 505 to search for the meaning of the received combined character string.

In S833, the request control unit 503 determines whether the search is successful. The phrase “successful search” means, for example, that the meaning of the combined character string is successfully obtained. In this case, the process proceeds according to the successful search.

In a case where the search is unsuccessful, in S834, the request control unit 503 transmits a notification that it is impossible to obtain the meaning of the combined character string to the portable device 103. Then in S835, the display/operation unit 508 of the portable device 103 displays an indication that it is impossible to obtain the meaning of the combined character string.

In a case where the search is successful in S833, in S836, the request control unit 503 transmits the meaning of the combined character string obtained by the search to the portable device 103.

In S837, the display/operation unit 508 of the portable device 103 displays the combined character string in the target cell. Then, since the user has obtained the meaning of the combined character string in the combining processing in S607, it is possible to immediately display the meaning of the combined character string in response to a user's action (a single-touch event for the word after combining).

As described above in the embodiment of the present invention, even in a case where segments corresponding to the word cells displayed as morphological analysis results by speech include an error or even in a case where segments corresponding to the word cells are different from the segments intended by a user, it is possible to easily correct segments through a multi-touch operation.

Incidentally, although the combining operation is performed by a pinch-in action in the present embodiment, other actions may be employed such as “a point and flick on a plurality of cells.” Similarly, although the segmentation operation is performed by a pinch-out action in the present embodiment, other actions may be employed such as a flick or a press and hold, which is performed by pointing a cell for a predetermined time.

The processing described in the present embodiment may be performed in either of the following states: a screen does not display a meaning cell as shown in FIG. 12A; and a screen displays a meaning cell as shown in FIG. 12B.

### Second Embodiment

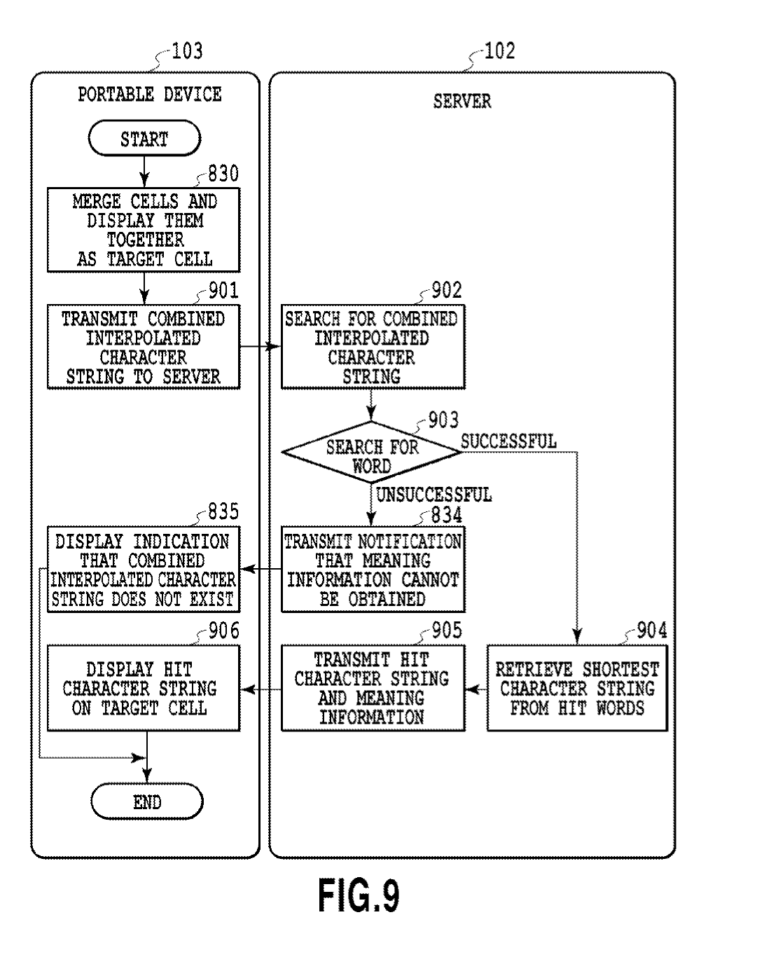

In a second embodiment, the content of the combining processing is different from that in the first embodiment as shown in FIG. 8. Hereinafter, the combining processing according to the second embodiment will be described with reference to FIG. 9. It should be noted that in FIG. 9, the steps which correspond to those of FIG. 8 are denoted by the same reference numerals.

First in S830, in the same manner as in the first embodiment, the display/operation unit 508 combines a plurality of word cells into one and displays it as a target cell.

Then in S901, the display/operation unit 508 generates a combined interpolated character string and transmits it to the request control unit 503 of the server 102. The combined interpolated character string has an asterisk “*” as an interpolation character between characters instructed to be combined.

Then in S902, the meaning search engine 505 searches for the meaning of the combined interpolated character string.

In the first embodiment, a search is made for the meaning of a combined character string as a new word. However, simply combining words into one as a combined character string may not allow a user to obtain an intended character string.

For instance, in a case where the speech recognition unit 501 recognizes “sajonorokaku,” which is a phrase carrying one meaning in Japanese, the morphological analysis engine 504 is very likely to retrieve two nouns: “sajo” and “rokaku.” In this case, the display/operation unit 508 displays these two nouns next to each other.

Accordingly, simply performing combining processing on word cells, as in the first embodiment, may produce the combined character string “sajorokaku” which is different from “sajonorokaku,” a speech utterance from a user. In this case, a search is likely to be made not according to the user's intention.

Moreover, a similar case may occur not only in Japanese but also in English and Chinese. A phrase such as “A of B” or “ [symbol] B” may be processed based on two words “A” and “B.”

Next in S903, it is determined whether or not the search by the meaning search engine 505 is successful.

In a case where the search is unsuccessful, the processing in S834 and S835 is performed as in the first embodiment. In a case where the search is successful in S903, in S904, the request control unit 503 selects a character string having the shortest character length from the hit words. Then in S905, the request control unit 503 transmits the hit character string and its meaning information to the display data transmission/reception unit 507. The display data transmission/reception unit 507 displays the hit character string as a target cell.

Incidentally, in S904 to S906, the character string having the shortest character length is selected as a hit character string. However, the display data transmission/reception unit 507 may display a certain number of words so that a user can select a hit word.

As described above, in the second embodiment, simple correction means can be presented even for the case where a simply combined character string does not have a meaning and thus interpolation between character strings are necessary. It should be noted that although in the present embodiment the combining operation is performed by a pinch-in action, other actions may be employed such as “a point and flick on a plurality of cells.”

### Third Embodiment

In the first and second embodiments, a user needs to make a pinch-out action on a single word cell and then select a candidate for segmentation in the segmentation processing. This may reduce the convenience of users.

In a third embodiment, direct segmentation processing is performed. In a case where a multi-tap is performed on a single word cell, a cursor is displayed at a tapped position, and if a pinch-out is performed with a cursor displayed, a character string is divided at a cursor position.

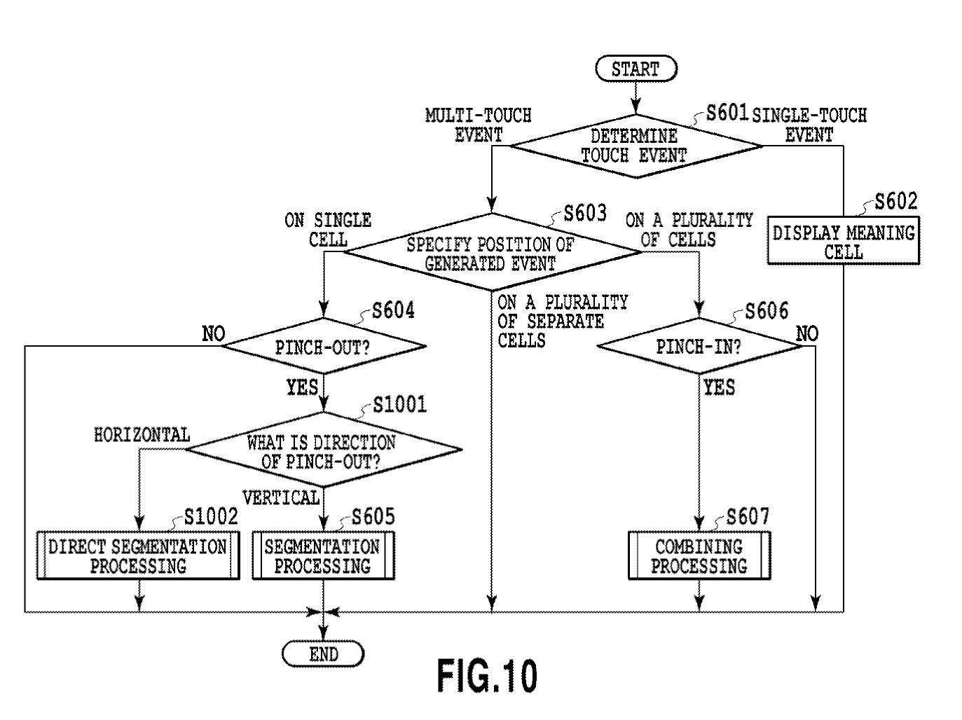

The event processing in the third embodiment is shown in FIG. 10. In FIG. 10, the steps which correspond to those of FIG. 6 are denoted by the same reference numerals.

As shown in FIG. 10, if a pinch-out is performed in S1001, a direction of the movement of two fingers touching the screen is determined.

In a case where the two fingers move in a vertical direction, the separation processing in S605 as described in the first embodiment is performed.

On the other hand, in a case where the two fingers move in a horizontal direction, direct segmentation processing (S1002) which does not require selection of a candidate for segmentation is performed.

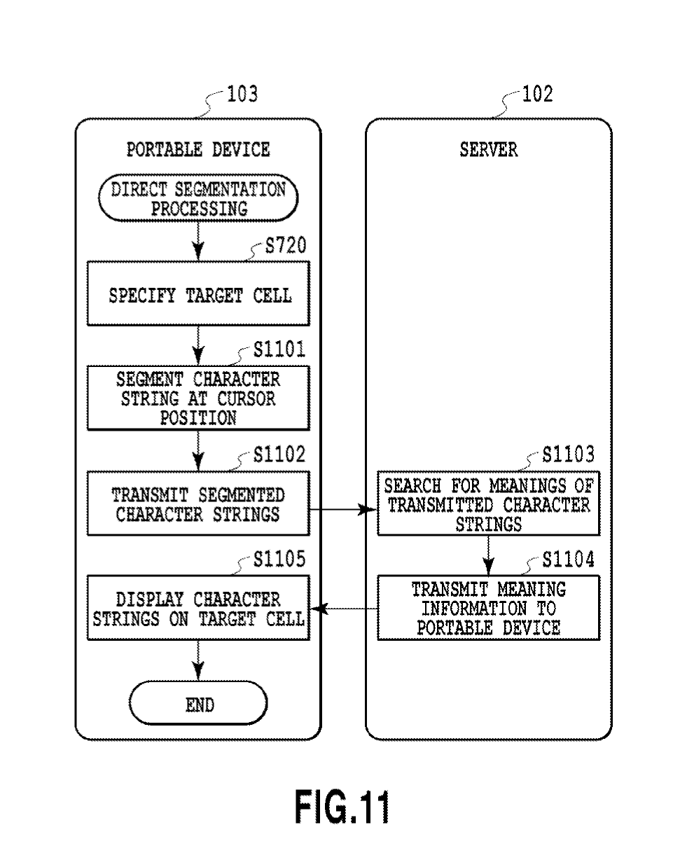

FIG. 11 shows the process of direct segmentation processing (S1002).

First, after a target cell is specified in S720, the display/operation unit 508 segments a character string associated with the target cell at a cursor position displayed in the pinch-out action in S1101.

Next in S1102, the display data transmission/reception unit 507 transmits segmented character strings to the server 102.

In S1103, the request control unit 503 of the server 102 searches for the meanings of the received character strings.

In S1104, the request control unit 503 transmits the meanings obtained by the search to the display data transmission/reception unit 507 of the portable device 103.

In S1105, the display data transmission/reception unit 507 displays the character strings on the target cell.

In the present embodiment, the segmentation processing can be performed simply by a pinch-out action.

Incidentally, although it has been shown that the segmentation operation is performed by a pinch-out action in the present embodiment, other actions may be employed such as a flick or a press and hold, which is performed by pointing a cell for a predetermined time.

The embodiments of the present invention have been described based on the first to third embodiments. Although it has been shown that the present invention can be carried out by the system of FIG. 1, it is also possible to include the function of the sever 102 in the portable device 103 so that the processing of the present invention can be performed by the portable device 103 alone.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-270524, filed Dec. 11, 2012, which is hereby incorporated by reference herein in its entirety.

What is claimed is:

1. An apparatus comprising:
a display unit configured to display as each item in a list each of a plurality of character strings obtained by performing morphological analysis on text data; and
a control unit, wherein
in a case where a first operation is performed on a plurality of items specified by a user in the list, the control unit is configured to control the display unit to display as an item in the list a combined character string obtained by combining character strings corresponding to the plurality of specified items, and
in a case where a second operation is performed on an item specified by the user in the list, the control unit is configured to control the display unit to display as new items in the list a plurality of character strings obtained by segmenting a character string corresponding to the specified item.

2. The apparatus according to claim 1, wherein the first operation is a pinch-in action.

3. The apparatus according to claim 1, wherein the second operation is a pinch-out action.

4. The apparatus according to claim 1, wherein in a case where a second operation is performed on an item specified by the user in the list, the control unit is configured to cause the display unit to display candidates for boundary positions and segment a character string into a plurality of character strings at a boundary position selected by the user from the candidates.

5. The apparatus according to claim 1, further comprising a search unit configured to search for a meaning of a character string corresponding to the item,
wherein in a case where a third operation is performed on an item specified by the user in the list, the control unit is configured to control the display unit to display a meaning of a character string corresponding to the specified item according to a search result of the search unit.

6. The apparatus according to claim 5, wherein in searching for a meaning of the combined character string, the search unit is configured to input an interpolation character between character strings corresponding to a plurality of items before combined by the first operation.

7. The apparatus according to claim 1, further comprising a conversion unit configured to convert speech data into text data, wherein the display unit is configured to display as each item in the list each of a plurality of character strings obtained by performing morphological analysis on text data converted by the conversion unit.

8. A method performed by an apparatus provided with a processor, the method comprising the steps of:
displaying as each item in a list each of a plurality of character strings obtained by performing morphological analysis on text data on a display; and
a controlling step, wherein in a case where a first operation is performed on a plurality of items specified by a user in the list displayed on the display, the display is controlled to display as an item in the list a combined character string obtained by combining character strings corresponding to the plurality of specified items, and
in a case where a second operation is performed on an item specified by the user in the list, the display is controlled to display as new items in the list a plurality of character strings obtained by segmenting a character string corresponding to the specified item.

9. A non-transitory computer readable storage medium storing a program for causing a computer to perform the image processing method according to claim 8.
